(19) United States
(12) Patent Application Publication
(10) Pub. No.: US 2007/0014943 A1
(43) Pub. Date: Jan. 18, 2007

(54) PROCESS FOR PRODUCING INTERMEDIATE TRANSFER MEMBER, INTERMEDIATE TRANSFER MEMBER AND IMAGE FORMING APPARATUS

(75) Inventors: Minoru Shimojo, Kanagawa (JP); Hiroyuki Kobayashi, Shizuoka (JP); Akihiko Nakazawa, Shizuoka (JP); Akira Shimada, Shizuoka (JP); Atsushi Tanaka, Shizuoka (JP); Tsunenori Ashibe, Kanagawa (JP); Takashi Kusaba, Shizuoka (JP); Hidekazu Matsuda, Shizuoka (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/533,179

(22) Filed: Sep. 19, 2006

Related U.S. Application Data
(62) Division of application No. 09/951,614, filed on Sep. 14, 2001.

(30) Foreign Application Priority Data
Mar. 23, 1999 (JP) 077968/1999

(51) Int. Cl. B41M 5/40

(52) U.S. Cl. 428/32.51

(57) ABSTRACT

A process is disclosed producing an intermediate transfer member used in an image-forming apparatus in which an image formed on a first image-bearing member is transferred to a second image-bearing member. The process has the steps of melt-extruding an extrusion material from a circular die by means of an extruder and thereafter making the same into a desired shape to obtain a cylindrical extruded product, and forming the resultant cylindrical extruded product into the intermediate transfer member. The cylindrical extruded product contains a thermoplastic resin and an ion-conductive resistance control agent, and a ratio of the diameter of the intermediate transfer member obtained to the die diameter of the circular die is from 0.5 to 4.0. Also disclosed are an intermediate transfer member obtained by the production process, and an intermediate transfer member having the intermediate transfer member.

### BACKGROUND OF THE INVENTION

1. Field of the Invention

This invention relates to a process for producing an intermediate transfer member used in an electrophotographic image-forming apparatus in which a toner image formed on a first image-bearing member is once transferred to an intermediate transfer member and is further transferred to a second image-bearing member (transfer medium) to obtain an image-formed medium. It also relates to an intermediate transfer member and an image-bearing member.

2. Related Background Art

Image-forming apparatus making use of an intermediate transfer member are effective as full-color image-forming apparatus or multi-color image-forming apparatus which sequentially superimpose and transfer a plurality of component color images corresponding to full-color image information or multi-color image information to output image-formed mediums on which full-color images or multi-color images have synthetically been reproduced, or as image-forming apparatus which have the function of full-color image formation or the function of multi-color image formation.

An example of an image forming apparatus employing an intermediate transfer belt as the intermediate transfer member is schematically shown in FIG. 1.

The apparatus shown in FIG. 1 is a full-color image-forming apparatus (copying machine or laser beam printer) utilizing an electrophotographic process. A medium-resistance elastic material is used in an intermediate transfer belt 20.

Reference numeral 1 denotes a drum-shaped electrophotographic photosensitive member (hereinafter “photosensitive drum”) repeatedly used as a first image bearing member, which is rotatively driven at a prescribed peripheral speed (process speed) in the direction of an arrow.

The photosensitive drum 1 is, in the course of its rotation, uniformly electrostatically charged to prescribed polarity and potential by means of a primary charging assembly 2, and then imagewise exposed to light 3 by an exposure means (e.g., a color-original image color-resolving/image-forming optical system, or a scanning exposure system comprising a laser scanner that outputs laser beams modulated in accordance with time-sequential electrical digital pixel signals of image information). Thus, an electrostatic latent image is formed which corresponds to a first color component image (e.g., a yellow color component image) of the intended color image.

Next, the electrostatic latent image formed is developed with a first-color yellow toner Y by means of a first developing assembly (yellow color developing assembly 41). At this stage, second to fourth developing assemblies (magenta color developing assembly 42, cyan color developing assembly 43 and black color developing assembly 44) each stand unoperated and do not act on the photosensitive drum 1, and hence the first-color yellow toner image is not affected by the second to fourth developing assemblies.

The intermediate transfer belt 20 is clockwise rotated at the same peripheral speed as the photosensitive drum 1. While passing through a nip formed between the photosensitive drum 1 and the intermediate transfer belt 20, the first-color yellow toner image formed and held on the photosensitive drum 1 is successively intermediately transferred to the periphery of the intermediate transfer belt 20 (primary transfer) by the aid of an electric field generated by a primary transfer bias applied to the intermediate transfer belt 20 through a primary transfer roller 62. The surface of the photosensitive drum 1 which has finished transferring the first-color yellow toner image, corresponding to the intermediate transfer belt 20, is cleaned by a cleaning assembly 13.

Subsequently, the second-color magenta toner image, the third-color magenta toner image and the fourth-color black toner image are sequentially likewise transferred superimposingly onto the intermediate transfer belt 20. Thus, synthesized color toner images corresponding to the intended full-color image is formed.

Reference numeral 63 denotes a secondary transfer roller, which is provided in such a way that it is axially supported in parallel to a secondary transfer opposing roller 64 and stands separable from the bottom surface of the intermediate transfer belt 20.

The primary transfer bias for sequentially superimposing and transferring the first to fourth-color toner images from the photosensitive drum 1 to the intermediate transfer belt 20 is applied from a bias source 29 in a polarity (+) reverse to that of each toner. The voltage thus applied is, e.g., in the range of from +100 V to +2 kV. In the step of primary transfer of the first- to third-color toner images from the photosensitive drum 1 to the intermediate transfer belt 20, the secondary transfer roller 63 may also be set separable from the intermediate transfer belt 20.

The synthesized color toner images transferred to the intermediate transfer belt 20 are transferred to a second image bearing member, transfer medium P, in the following way: The secondary transfer roller 63 is brought into contact with the intermediate transfer belt 20 and simultaneously the transfer medium P is fed at a prescribed timing from a paper feed roller 11 through a transfer medium guide 10 until it reaches a contact nip formed between the intermediate transfer belt 20 and the secondary transfer roller 63, where a secondary transfer bias is applied to the secondary transfer roller 63 from a power source 28. On account of this secondary transfer bias, the synthesized color toner images are transferred from the intermediate transfer belt 20 to the second image bearing member transfer medium P (secondary transfer). The transfer medium P to which the toner images have been transferred are guided into a fixing assembly 15 and are heat-fixed.

After the toner images have been transferred to the transfer medium P, a charging member 7 for cleaning is brought into contact with the intermediate transfer belt 20, and a bias with a polarity reverse to that of the photosensitive drum 1 is applied, whereupon electric charges with a polarity reverse to that of the photosensitive drum 1 are imparted to toners not transferred to the transfer medium P and remaining on the intermediate transfer belt 20 (i.e., transfer residual toners). Reference numeral 26 denotes a bias power source. The transfer residual toners are electrostatically transferred to the photosensitive drum 1 at the nip between the photosensitive drum 1 and the intermediate transfer belt 20 and the vicinity thereof, thus the intermediate transfer belt 20 is cleaned.

Compared with conventional full-color electrophotographic apparatus having an image-forming apparatus in which a second image bearing member (transfer medium) is fastened or attracted onto a transfer drum and toner images are transferred thereto from a first image bearing member, e.g., a transfer unit as disclosed in Japanese Patent Application Laid-Open No. 63-301960, full-color electrophotographic apparatus having an image-forming apparatus making use of the intermediate transfer member described above have such an advantage that a variety of second image bearing member transfer mediums can be selected without regard to their width, length and thickness, including thin paper (40 g/m² paper) and up to thick paper (200 g/m² paper) such as envelopes, post cards and labels. This is because any processing or control (e.g., the transfer material is held with a gripper, attracted, and made to have a curvature) is not required for the second image bearing member transfer medium. Because of such advantages, full-color copying machines and full-color printers making use of intermediate transfer members have already begun to be available in the market.

Various processes for producing such belts and cylindrical tubes used in intermediate transfer members are already known in the art. For example, Japanese Patent Application Laid-Open Nos. 3-89357 and 5-345368 disclose a process for producing a semiconducting belt by extrusion. Japanese Patent Application Laid-Open No. 269849 also discloses a process in which a belt is obtained by joining both ends of a sheet to make a cylindrical form. Japanese Patent Application Laid-Open No. 9-269674 discloses a process in which a belt is obtained by forming a multi-layer coating film on a cylindrical substrate and finally removing the substrate. Meanwhile, Japanese Patent Application Laid-Open No. 5-77252 discloses a seamless belt obtained by centrifugal molding. These processes have merits and demerits individually.

For example, in the extrusion, the production of a thin-layer belt having a thickness of 100 μm or smaller involves considerable problems. Even if possible, the process tends to cause uneven wall thickness and uneven electrical resistance caused by such uneven wall thickness, bringing about problems in performance and quality stability as intermediate transfer members. Also, in the case where both ends of a sheet are joined, the difference in height and decrease in tensile strength at the joint present problems. Still also, processes making use of solvents as in cast molding, coating and centrifugal molding require many steps of preparing a coating solution, applying it and removing the solvent, resulting in a high cost. Moreover, such processes involves matters that affect environment as in the collection of solvents. Accordingly, further improvements have been required.

In addition, conductive members used in electrophotography as in conventional intermediate transfer members make use of rubbers, elastomers and resins as base materials, and filler-type conductive materials as exemplified by commonly available conductive carbon, conductive metal power and carbon fiber are added thereto to make an adjustment to prescribed electrical resistance. For the adjustment to prescribed electrical resistance, however, these filler-type conductivity-providing materials must be added in a large quantity, so that the conductive members themselves may have a high hardness. Also, the material is present in the base material in a merely dispersed state, and hence, in an attempt to obtain conductive members in a medium resistance region which can be said to be semiconductive, it is difficult to keep the electrical resistance scattering of the conductive layer small unless the step of dispersion is especially taken into consideration. The conductive members have had such disadvantages.

### SUMMARY OF THE INVENTION

An object of the present invention is to provide an intermediate transfer member which ensures a very high transfer efficiency from the first image-bearing member to the intermediate transfer member and a very high transfer efficiency from the intermediate transfer member to the second image-bearing member, and is superior in applicability; a process for producing such an intermediate transfer member at a low cost and in a small number of steps; and an image-forming apparatus having the intermediate transfer member.

Another object of the present invention is to provide an intermediate transfer member which may bring about neither image blank ares caused by poor transfer nor image density unevenness and is rich in durability (running performance); a process for producing such an intermediate transfer member; and an image-forming apparatus having the intermediate transfer member.

To achieve the above objects, the present invention provides a process for producing an intermediate transfer member which is used in an image-forming apparatus in which an image formed on a first image-bearing member is transferred to a second image-bearing member; the process comprising the steps of:

melt-extruding an extrusion material from a circular die by means of an extruder and thereafter making it into a desired shape to obtain a cylindrical extruded product; and

forming the resultant cylindrical extruded product into the intermediate transfer member;

the cylindrical extruded product containing a thermoplastic resin and an ion-conductive resistance control agent; and

a ratio of a diameter of the intermediate transfer member obtained to a die diameter of the circular die is from 0.5 to 4.0.

The present invention also provides an intermediate transfer member obtained by the above production process, and an intermediate transfer member having the intermediate transfer member.

### BRIEF DESCRIPTION OF THE DRAWINGS

FIG. 1 is a schematic view of a full-color image-forming apparatus employing an intermediate transfer member (intermediate transfer belt).

FIG. 2 is a schematic view of an apparatus for carrying out an example of the intermediate transfer member production process of the present invention.

FIG. 3 is a partial schematic view of an intermediate transfer member (intermediate transfer belt) having a double-layer construction according to the present invention.

FIG. 4 is a partial schematic view of an intermediate transfer member (intermediate transfer belt) having a triple-layer construction according to the present invention.

FIG. 5 is a whole schematic view of the intermediate transfer member (intermediate transfer belt) having a triple-layer construction according to the present invention.

FIG. 6 is a schematic view of an apparatus for carrying out another example of the intermediate transfer member production process of the present invention.

FIG. 7 is a schematic view of an apparatus for measuring the electrical resistance of the intermediate transfer member of the present invention.

FIG. 8 is a schematic view of positions at which the volume resistivity and surface resistivity of the intermediate transfer member of the present invention are measured.

### DESCRIPTION OF THE PREFERRED EMBODIMENTS

The intermediate transfer member of the present invention comprise a cylindrical extruded product obtained by melt-extruding an extrusion material from a circular die by means of an extruder and thereafter making it into a desired shape. The cylindrical extruded product contains a thermoplastic resin and an ion-conductive resistance control agent, and the ratio of the diameter of the intermediate transfer member obtained to the die diameter of the circular die is from 0.5 to 4.0.

Embodiments of the present invention are described below in detail.

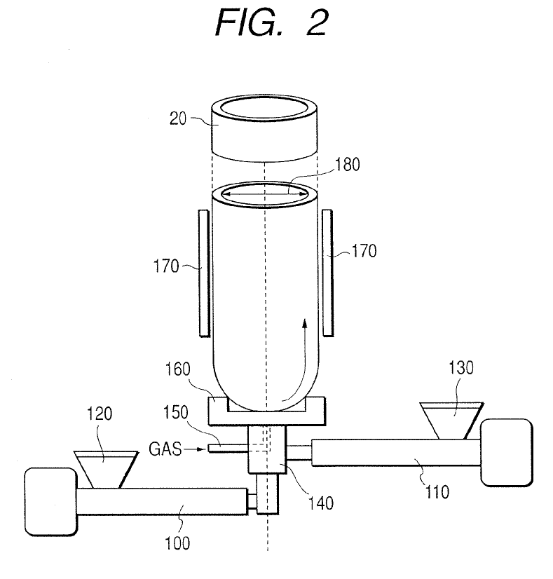

FIG. 2 shows an extrusion apparatus according to the present invention. This apparatus consists basically of an extruder, an extruder die (circular die) and a gas blowing unit. As shown in FIG. 2, the apparatus has two extruders 100 and 110 so that a belt of double-layer construction can be extruded. In the present invention, however, at least one extruder may be provided.

A single-layer intermediate transfer member may be produced by a process described below. First, a resin, a resistance control agent and additives are premixed under the desired formulation and thereafter kneaded and dispersed to prepare an extrusion material, which is then put into a hopper 120 installed to the extruder 100. The extruder 100 has a preset temperature, extruder screw construction and so forth which have been so selected that the extrusion material may have a melt viscosity necessary for enabling the extrusion into a belt in the post step and also the materials constituting the extrusion material can mutually uniformly be dispersed.

The extrusion material is melt-kneaded in the extruder 100 into a melt, which then enters an extruder die 140. The extruder die 140 is provided with a gas feed passage 150. Through the gas feed passage 150, a gas such as air is blown into the extruder die 140, whereupon the melt having passed through the extruder die 140 inflates while scaling up in the diametrical direction.

The extruded product having thus inflated is drawn upward while being cooled by a cooling ring 160. At this stage, the extruded product passes through the space defined by a dimension stabilizing guide 170, so that its final shape and size 180 are determined. This product is further cut in desired width, thus an intermediate transfer member (intermediate transfer belt) 20 of the present invention can be obtained.

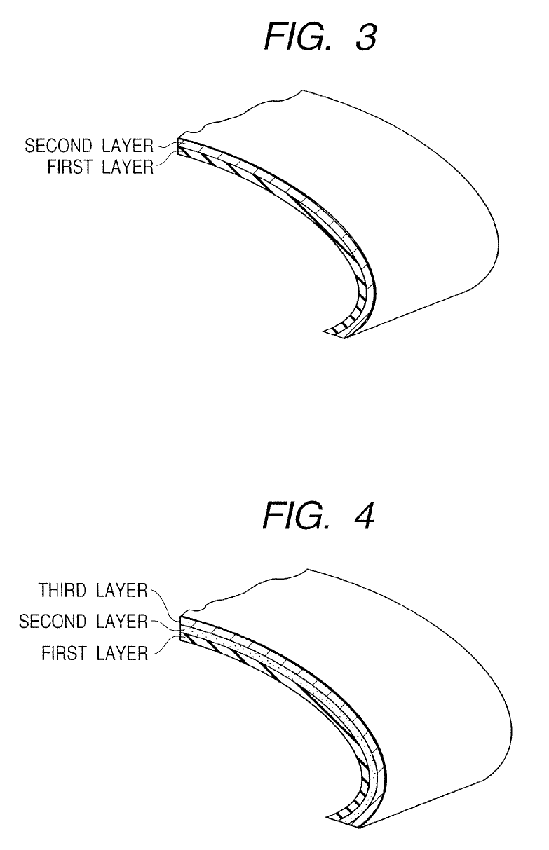

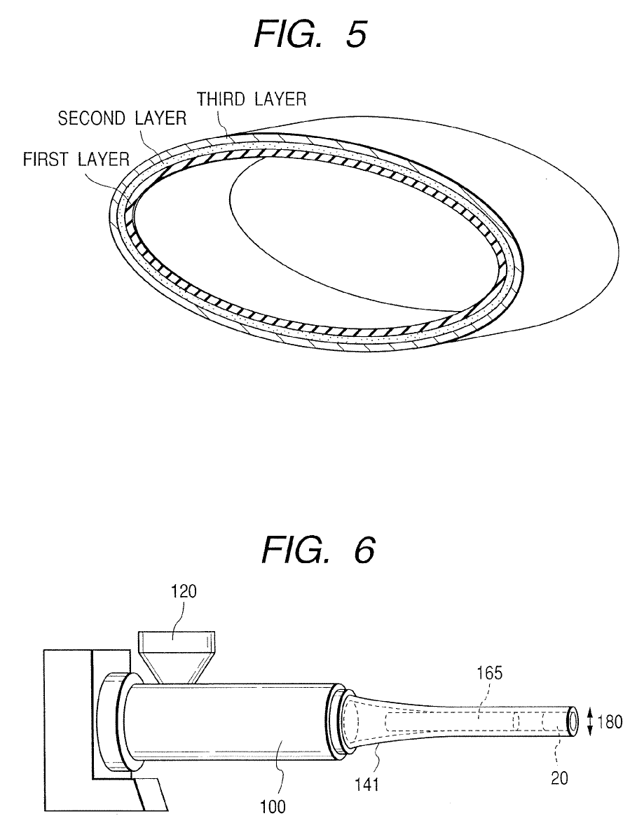

The above description concerns a single-layer belt. In the case of a double layer, an extruder 110 is further provided as shown in FIG. 2. Simultaneously with the kneaded melt in the extruder 100, a kneaded melt in the extruder 110 is sent to a double-layer extruder die 140, and the two layers are scale-up inflated simultaneously, thus a double-layer belt can be obtained. Of course, in the case of triple- or more layers, the extruder may be provided in the number corresponding to the number of layers. Examples of intermediate transfer belts of double-layer construction and triple-layer construction are shown in FIGS. 3 to 5.

Thus, the present invention makes it possible to extrude not only intermediate transfer belts of single-layer construction but also those of multi-layer construction in a good dimensional precision through one step and also in a short time. The fact that the extrusion can be made in a good precision in a short time well suggests that mass production and low-cost production can be made.

In addition, when the cylindrical extruded product is ejected through the leading end of a circular die by extrusion of the extruder, the ratio of the diameter (D2) of the intermediate transfer member to the die diameter (D1) of the circular die, D2/D1, is set to be 0.5 to 4.0, in particular, D2/D1 of 1.0 to 4.0. This is preferable because in such a case the wall thickness of the intermediate transfer member can be made smaller than the die gap to bring about an improvement in wall thickness precision of the intermediate transfer member. Also, setting the ratio of D2/D1 to be 1.0 or higher is advantageous in that the intermediate transfer member is stretched in the peripheral direction to bring about an improvement in Young's modulus in the peripheral direction, so that any color aberration in the direction of secondary scanning can be made to less occur. Here, if the ratio of D2/D1 is higher than 4.0, the cylinder having inflated may have a poor stability to make it impossible to attain good dimensional precision and smoothness.

As a process by which the ratio of D2/D1 is set to be 1.0 or higher, a process may be used in which a gas having a pressure higher than atmospheric pressure is blown into the cylindrical extruded product ejected through the leading end of the circular die by extrusion of the extruder, to form the cylinder continuously while inflating it. Here, the gas to be blown may be selected from, but is not limited to, air, and besides, nitrogen, argon and carbon dioxide.

In the above process, where a resin having a low melt viscosity is used, the cylinder extruded from the circular die may not successfully inflate, e.g., holes may be made, even when tried to inflate, so that the ratio of D2/D1 may be obliged to be set lower than 1.0 in some cases. Even in such cases, too, the ratio of D2/D1 may be made as high as possible, stated specifically, the ratio of D2/D1 may be set to be 0.5 or higher, whereby any poor wall thickness precision of the intermediate transfer member obtained can be kept minimum. The ratio of D2/D1 may preferably be in a value of from 0.8 to 2.5, and more preferably in the range of from 0.9 to 2.0.

FIG. 6 shows another process for producing the intermediate transfer member according to the present invention.

The extrusion material put into a hopper 120 passes an extruder 100, in the course of which it comes into a melt having been uniformly dispersed, and is extruded from a circular extruder die 141 into a cylindrical belt. The inner surface of the belt thus extruded is cooled while coming into contact with an interior cooling mandrel 165, and is regulated to have the desired size 180 to obtain an intermediate transfer belt 20 according to the present invention. Here, the ratio of the diameter (D2) of the intermediate transfer member to the die diameter (D1) of the circular die, D2/D1, may preferably be set to be 0.5 to 4.0, and more preferably, the ratio of D2/D1 may be in the range of from 1.0 to 4.0.

In the present invention, the thermoplastic resin is meant to be a resin capable of softening or melting upon heating to become extrudable. For example, usable are one or more types selected from an ethylene-vinyl alcohol copolymer (EVOH), polyethylene, polypropylene, polystyrene, ABS resins, polyacetal, polycarbonate, polyesters (such as polyethylene terephthalate and polybutylene terephthalate), methacrylic resins, aliphatic or other-type polyamides, modified polyphenylene ethers, polyphenylene sulfide, polyarylates, polysulfone, polyether sulfone, polyamide-imide, thermoplastic polyimides, polyether imide, polyether ether ketone, polyether ketone, polyether nitrile, aliphatic polyketones, polymethyl pentene, and fluorine resins (such as polyvinylidene fluoride, an ethylene-tetrafluoroethylene copolymer, tetrafluoroethylene-perfluoroalkyl vinyl ether copolymers, a fluoroethylene-propylene copolymer and tetrafluoroethylene). Other known thermoplastic resins (e.g., polymer alloys) may also be used. Examples are by no means limited to the above materials.

The ion-conductive resistance control agent used to regulate the values of electrical resistance of the intermediate transfer member of the present invention may include cationic surface-active agents, for example, quaternary ammonium salts such as perchlorates, chlorates, hydroborofluorides, sulfates, ethosulfates, or benzyl halides (for example, benzyl bromide or benzyl chloride) of lauryl trimethylammonium, stearyl trimethylammonium, octadodecyl trimethylammonium, dodecyl trimethylammonium, hexadecyl trimethylammonium or modified fatty acid-dimethyl ethylammonium; anionic surface-active agents such as aliphatic sulfonates, higher-alcohol sulfuric esters, higher-alcohol sulfuric esters added with ethylene oxide, higher-alcohol phosphoric esters and higher-alcohol phosphoric esters added with ethylene oxide; amphoteric surface-active agents such as betaines; antistatic agents, for example, a non-ionic antistatic agents such as higher-alcohol ethylene oxides, polyethylene glycol fatty acid esters and polyhydric alcohol fatty acid esters; salts of Group I metals of the periodic table (e.g., Li⁺, Na⁺ and K⁺), such as LiCF₃SO₃, NaClO₄, LiClO₄, LiAsF₆, LiBF₄, NaSCN, KSCN, and NaCl, electrolytes such as NH₄⁺, salts of Group II metals of the periodic table (e.g., Ca²⁺ and Ba²⁺), such as Ca(ClO₄)₂; and any of the above antistatic agents having at least one group having active hydrogen capable of reacting with an isocyanate, such as a hydroxyl group, a carboxyl group and a primary or secondary amine group. It may further include complexes of the above material and a polyhydric alcohol such as 1,4-butanediol, ethylene glycol, polyethylene glycol or propylene glycol or its derivative; or complexes of the above material and a monool such as ethylene glycol monomethyl ether or ethylene glycol monoethyl ether. One or two or more types selected from these may be used. Examples are by no means limited to the above materials and other known ion-conductive resistance control agents may be used.

Incorporation of any of these thermoplastic resins and ion-conductive resistance control agent in the intermediate transfer member enables its electrical resistance to be kept at a small scattering, so that a very high transfer efficiency from the first image-bearing member to the intermediate transfer member and a very high transfer efficiency from the intermediate transfer member to the second image-bearing member can be achieved.

As the ion-conductive resistance control agent, more preferred are cationic or anionic surface-active agents having good compatibility with the thermoplastic resin. Among these, quaternary ammonium salts are particularly preferred as being little causative of variations in electrical resistance of the intermediate transfer member even in the state of long-time electrification brought by any running in an environment of high temperature and high humidity.

Meanwhile, the amount of the ion-conductive resistance control agent formulated in the intermediate transfer member is inseparably related with the production process of the present invention. If the ion-conductive resistance control agent is in an amount more than 20% by weight based on the total weight of the intermediate transfer member, however the thermoplastic resin formulated simultaneously is soft enough to be stretchable and expandable, the extrusion material may turn into a plastic melt after it has passed the extruder, tending to make it difficult to carry out the scale-up inflation as desired. Even if the scale-up inflation can be carried out, any granular structure, fish eyes and holes caused by particles of the ion-conductive resistance control agent tend to occur frequently, which may cause image blank areas caused by poor transfer.

Japanese Patent Application Laid-Open Nos. 3-89357 and 5-345368 refer to a resistance control agent in relation to extrusion, but this extrusion is quite different from the extrusion with the blowing of air as in the present invention. In addition, the ion-conductive resistance control agent has a superior dispersibility but on the other hand has a great humidity dependence. Hence, its use in a large quantity may also cause the image blank areas caused by poor transfer. Accordingly, in the present invention, the ion-conductive resistance control agent may preferably be added in an amount of 20% by weight or smaller, and more respectively 10% by weight or smaller.

Of course, the above problems do not occur at the time of extrusion if the ion-conductive resistance control agent is not contained. However, in order to construct the intermediate transfer member of the present invention, it is necessary to use extrusion materials that may provide the intermediate transfer member with the electrical resistance in a desired value ranging between 1×10⁰ Ω and 1×10¹⁴ Ω. For this end, the process of the present invention is easy and preferable in which the ion-conductive resistance control agent is incorporated in a high-resistance resin to control the electrical resistance. Here, it is preferable for the intermediate transfer member to have an electrical resistance of from 1×10⁰ Ω to 1×10¹⁴ Ω, because the conditions to be set for transfer and cleaning in the intermediate transfer member of the present invention can readily be regulated.

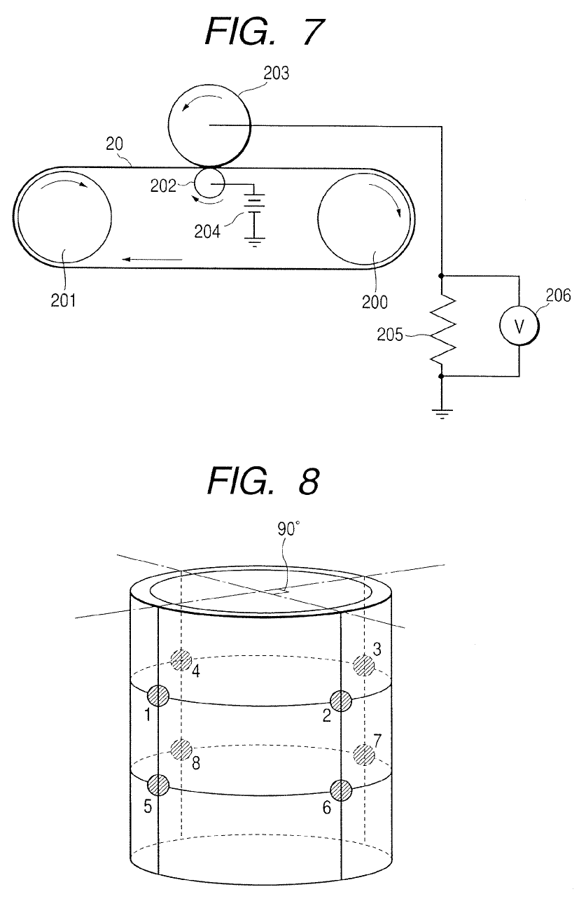

The electrical resistance of the intermediate transfer member is measured in the following way.
(1) An intermediate transfer belt 20 is put over rollers 200 and 201 as shown in FIG. 7, and the intermediate transfer belt 20 is set to be held between metallic rollers 202 and 203, to which a direct-current power source 204, a resistor 205 having a suitable electrical resistance and a potentiometer 206 are connected.
(2) The belt is so driven by a drive roller that the intermediate transfer belt surface may move at a speed of from 100 to 300 mm/second.
(3) A voltage is applied from the direct-current power source to the circuit within the range of from 100 V to 1 kV, and potential difference Vr at both ends of the resistor is read on the potentiometer. Measurement is made in an atmosphere of atmospheric temperature 23±5° C./humidity 50±10% RH.
(4) From the potential difference Vr found, the value of electrical current I flowing through the circuit is determined.
(5) Electrical resistance of the intermediate transfer belt: applied voltage/electrical current I.

The intermediate transfer member obtained by the production process of the present invention is produced by extrusion of the extruder from the circular die, and hence is a semiconductive seamless belt, having no seam. Thus, it does not have any uneven electrical resistance or uneven surface that may be caused by seams, and hence any difficulties such as uneven image density, dimensional changes during running and break may hardly occur.

When the intermediate transfer member is obtained by ejecting the cylindrical extruded product by extrusion of the extruder through the leading end of the circular die, a cylindrical or tubular intermediate transfer member may be formed in such a way that the thermoplastic resin composition member (intermediate transfer member) has a wall thickness smaller than the die gap of the circular die. This enables an improvement in wall thickness precision of the thermoplastic resin composition member. The reason therefor is considered as follows.

The intermediate transfer member has a wall thickness of as small as about 50 to 300 μm. Accordingly, where the intermediate transfer member has a wall thickness set equal to the value of the die gap, any aberration of, e.g., 10 μm in the die gap necessarily appears as an aberration of 10 μm also in the wall thickness of the intermediate transfer member. On the other hand, in the case when the intermediate transfer member is made to have a wall thickness smaller than the die gap, e.g., when an intermediate transfer member having a wall thickness of 150 μm is prepared using a die gap of 1 mm, even any aberration of 10 μm in the die gap appears as an aberration of only 1.5 μm in the wall thickness of the intermediate transfer member. Thus, it is considered that, in the case of “die gap>intermediate transfer member wall thickness”, the intermediate transfer member is improved in wall thickness precision. Incidentally, the wall thickness precision herein referred to is concerned with both an aberration of average wall thickness of the intermediate transfer member with respect to an intended value and a wall thickness unevenness of the intermediate transfer member.

When the intermediate transfer member is obtained by ejecting the cylindrical extruded product by extrusion of the extruder through the leading end of the circular die, a cylindrical or tubular intermediate transfer member may be obtained by taking off the film (tubular belt) at a speed higher than the speed at which the cylindrical extruded product is ejected. This enables achievement of an improvement in wall thickness precision of the intermediate transfer member and at the same time an improvement in Young's modulus in the lengthwise direction (i.e., the direction of thrust). The reason therefor is considered as follows.

The improvement in wall thickness precision is explained first. When a molten resin is extruded from the circular die, it so behaves as to become large in wall thickness than the die gap (i.e., die swell) by the Barus effect. Hence, any aberration of the die gap is amplified to become reflected on the wall thickness of the intermediate transfer member. However, setting the take-off speed of the film to be higher than the ejection speed, the intermediate transfer member is stretched out to become thin, and hence the aberration of wall thickness (and unevenness of wall thickness) can be made small in the absolute value.

The Young's modulus is explained next. Setting the take-off speed of the extruded cylinder to be higher than the ejection speed, the cylinder is brought into a state in which it has been monoaxially stretched in the direction of machine direction (MD). This brings about an improvement in Young's modulus in the lengthwise direction of the intermediate transfer member to preferably make the color aberration less occur that is in the direction of main scanning of a laser scanner (aberration occurring when toner images having different colors are superimposed).

As the extruder for extruding the cylindrical extruded product in the production process for the intermediate transfer member, a twin-screw extruder may be used, whereby the polymer and various additives can well be dispersed and mixed to enable labor saving in the step of dispersion or omission of that step. Hence, the intermediate transfer member can be produced at a low cost. Also, the dispersion and mixing well carried out are preferable because variations in electrical resistance (uneven electrical resistance) due to any dispersion strength can be made small and any faulty transfer due to the interference of power sources between transfer stations (primary transfer and secondary transfer) and any uneven transfer and leak (insulation breakdown) which are due to concentration of electrical currents at a low-resistance portion may hardly occur.

When the intermediate transfer member is adjusted to any desired width, the cylindrical film ejected by extrusion of the extruder through the leading end of the circular die may also preferably continuously be cut in the direction falling at right angles (cross direction) with its lengthwise direction to obtain intermediate transfer members. Where it is not cut in the cross direction, the intermediate transfer member tends to have width (size in the lengthwise direction) different at some places. Hence, when such a member is put over support rollers and rotated, it may travel by a winding course to tend to cause wrinkles, so that no good images may be obtained.

The intermediate transfer member may also preferably have a maximum value of volume resistivity in its peripheral direction (radial direction) within 100 times the minimum value thereof. If its maximum value is greater than 100 times the minimum value, uneven transfer may occur in the peripheral direction or the interference of power sources between transfer stations (e.g., interference of power sources between a bias power source for primary transfer and a bias power source for secondary transfer) may occur.

The intermediate transfer member may also preferably have a maximum value of surface resistivity in its peripheral direction (radial direction) within 100 times the minimum value thereof. If its maximum value is greater than 100 times the minimum value, the interference of power sources between transfer stations (e.g., interference of power sources between a bias power source for primary transfer and a bias power source for secondary transfer) may occur.

The intermediate transfer member may also preferably have a maximum value of volume resistivity in its lengthwise direction (thrust direction) within 100 times the minimum value thereof. If its maximum value is greater than 100 times the minimum value, uneven transfer may occur in the lengthwise direction, the insulation breakdown of the intermediate transfer member may occur because of excessive electrical current flowing into portions having minimum electrical resistance, or the image-forming apparatus may cause misoperation.

The intermediate transfer member may also preferably have a maximum value of surface resistivity in its lengthwise direction (thrust direction) within 100 times the minimum value thereof. If its maximum value is greater than 100 times the minimum value, uneven transfer in the lengthwise direction and faulty cleaning may occur; the faulty cleaning being caused when any transfer residual toner remaining on the intermediate transfer member is charged by a charging member and thereafter the transfer residual toner is removed by cleaning and when the bias electric current applied from the transfer residual toner charging member flows concentratedly at low-resistance portions of the intermediate transfer member to make it impossible to uniformly charge the transfer residual toner remaining on the intermediate transfer member.

In the present invention, the volume resistivity and surface resistivity of the intermediate transfer member is measured in the following way.

—Measuring Machine—

Resistance meter: Ultra-high resistance meter R8340A (manufactured by Advantest Co.)

Sample box: Sample box TR42 for ultra-high resistance meter (manufactured by Advantest Co.)

(The main electrode is 22 mm in diameter, and the guard-ring electrode is 41 mm in inner diameter and 49 mm in outer diameter.)

—Sample—

The intermediate transfer member (wall thickness: about 30 to 300 μm) is cut in a circular form of 56 mm in diameter. After cutting, it is provided, on its one side, with an electrode over the whole surface by forming a Pt—Pd deposited film and, on the other side, provided with a main electrode of 25 mm in diameter and a guard-ring electrode of 38 mm in inner diameter and 50 mm in outer diameter by forming Pt—Pd deposited films. The Pt—Pd deposited films are formed by carrying out vacuum deposition for 2 minutes using Mild Sputter E1030 (manufactured by Hitachi Ltd.). The one on which the vacuum deposition has been carried out is used as the sample.

—Measurement Conditions—

Measurement atmosphere: 23° C., 55% humidity. (Here, the measuring sample is previously kept left in an atmosphere of 23° C. and 55% humidity for 12 hours or longer.)

Measurement mode: Program mode 5 (discharge for 10 seconds, charge and measurement for 30 seconds) Applied voltage: 1 to 1,000 V

The applied voltage may arbitrarily be selected within the range of from 1 to 1,000 V which is part of the range of the voltage applied to the intermediate transfer member used in the image forming apparatus of the present invention. Also, the applied voltage used may appropriately be changed within the above range of applied voltage in accordance with the resistance value, thickness and breakdown strength of the sample. Also, as long as the volume resistivity and surface resistivity at a plurality of spots, measured at any one-point voltage of the above applied voltage, are included in the above preferable resistance range, the resistivities are judged to be within those intended in the present invention.

The intermediate transfer member obtained after extrusion may preferably have a wall thickness in the range of from 50 to 300 μm, particularly from 55 to 250 μm, and more preferably from 60 to 200 μm. In the present invention, the kneaded melt extruded from the extruder die scale-up inflates, and hence the wall thickness of the extruded product is restricted to a certain extent together with the controllability of electrical resistance.

In a wall thickness larger than 300 μm, uniform scale-up inflation may be made with difficulty to tend to cause a difficulty in the uniformity of electrical resistance, simultaneously making it difficult to attain uniform wall thickness for the part the wall thickness is large. Also, when a belt having such a large wall thickness is used as the intermediate transfer member, it may be hindered from smooth traveling because of its fairly high rigidity and poor flexibility, to tend to cause deflection or torsion.

In a wall thickness smaller than 50 μm, problems in practical use may occur such that tensile strength of the intermediate transfer member is lowered and the belt becomes loose during running under stretch-rotation to cause elongation gradually. Taking account of the above problems in practical use, the production process of the present invention is not suited for the production of belts with a thickness smaller than 50 μm because of thin layers, although it can deal with such thickness, enabling achievement of stable electrical resistance.

The present invention will be described below in greater detail by giving Examples. In the following Examples, “part(s)” is part(s) by weight.

### EXAMPLE 1

| | | |
|---|---|---|
| Polyethylene terephthalate resin | 60 | parts |
| Polycarbonate resin | 40 | parts |
| Lithium perchlorate | 8 | parts |

The above formulation was kneaded by means of a twin-screw extruder, and the lithium perchlorate was well uniformly dispersed in the binder resins so as to provide the desired electrical resistance, thus an extrusion material (1) was obtained. This material was further made into a kneaded product having particle diameters of 1 to 2 mm.

Next, the above kneaded product was put into the hopper 120 of the single-screw extruder 100 shown in FIG. 2, and was melt-extruded with heating to form a melt. The melt was subsequently brought to an extrusion die 140 for extruding a cylindrical single-layer product of 100 mm diameter and 300 μm thick. Then, air was blown from the gas feed passage 150 while the melt was extruded from the die, to scale-up inflate the extruded product into a cylindrical extruded product of 140 mm in diameter and 120 μm in wall thickness as final shape size 180. This product was further cut in a belt width of 250 mm to obtain an intermediate transfer member (1).

The electrical resistance of this intermediate transfer member (1) was 5.5×10⁹ Ω. Also, using the electrical resistance measuring apparatus (manufactured by Advantest Co.) described previously, a voltage of 100 V was applied to measure the electrical resistance of the belt at four spots in its peripheral direction and at two spots in its axial direction (lengthwise direction) at each position of the former, eight spots in total, as shown in FIG. 8, and any scattering of volume resistivity and surface resistivity in the belt was examined, where the measurements at the eight spots were within two figures. Scattering in the measurement of wall thickness at the like positions was within 120 μm±10 μm. Upon visual observation of the intermediate transfer member (1), none of foreign matter or faulty extrusion such as granular structure and fish eyes was seen on its surface.

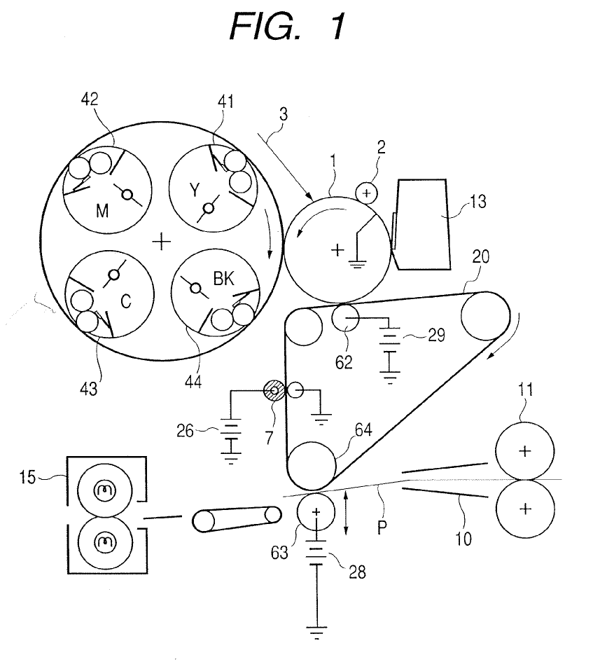

This intermediate transfer member (1) was set in the full-color electrophotographic apparatus shown in FIG. 1, and full-color images were printed on 80 g/m² paper to measure transfer efficiencies; the transfer efficiencies being defined as follows:
Primary transfer efficiency (efficiency of transfer from photosensitive drum to intermediate transfer belt)=toner image density on intermediate transfer belt/(transfer residual toner image density on photosensitive drum+toner image density on intermediate transfer belt)
Secondary transfer efficiency (efficiency of transfer from intermediate transfer belt to paper)=toner image density on paper/(toner image density on paper+transfer residual toner image density on intermediate transfer belt)

The primary transfer efficiency and secondary transfer efficiency of this intermediate transfer member (1) were as good as 95% and 92%, respectively. Then, full-color images were continuously printed on 5,000 sheets. Good images were obtainable from the beginning without causing any uneven image density and image blank areas caused by poor transfer, and without causing any color aberration or faulty cleaning ascribable to elongation set of the belt even after running on 5,000 sheets. Moreover, the same surface properties as the initial ones remained unchanged without causing any crazing, abrasion and wear of the surface.

### EXAMPLE 2

| | | |
|---|---|---|
| Polybutylene terephthalate resin | 70 | parts |
| Polyacetal resin | 30 | parts |
| Aliphatic sulfonate | 5 | parts |

The above formulation was kneaded and dispersed by means of a twin-screw extruder to obtain a uniform kneaded product. This was designated as an extrusion material (2). Next, the subsequent procedure in Example 1 was repeated to obtain an intermediate transfer member (2) of 141 mm in diameter, 125 μm in wall thickness and 250 mm in belt width.

The electrical resistance of this intermediate transfer belt (2) was 1.3×10¹⁰ Ω. Also, the uniformity of volume resistivity and surface resistivity at the eight spots in the intermediate transfer member as shown in FIG. 8 was within one figure in both the peripheral direction and the lengthwise direction. The scattering in the measurement of wall thickness at the like positions was within 125 μm±12 μm. Upon visual observation of the intermediate transfer member (2), none of foreign matter or faulty extrusion such as granular structure and fish eyes was seen on its surface. Also, the primary transfer efficiency and secondary transfer efficiency of this intermediate transfer member (2) were as good as 97% and 93%, respectively.

Next, full-color images were continuously printed on 5,000 sheets in the same manner as in Example 1. Good images were obtainable from the beginning without causing any uneven image density and image blank areas caused by poor transfer, and without causing any color aberration or faulty cleaning ascribable to elongation set of the belt even after running on 5,000 sheets. Moreover, the same surface properties as the initial ones remained unchanged without causing any crazing, abrasion and wear of the surface.

### EXAMPLE 3

An extrusion material (3) was prepared in the same manner as in Example 2 except that tetrabutylammonium perchlorate was used in place of the aliphatic sulfonate. Next, the subsequent procedure in Example 1 was repeated to obtain an intermediate transfer member (3) of 143 mm in diameter, 126 μm in wall thickness and 250 mm in belt width.

The electrical resistance of this intermediate transfer belt (3) was 8.7×10¹⁰ Ω. Also, the uniformity of volume resistivity and surface resistivity at the eight spots in the intermediate transfer member as shown in FIG. 8 was within one figure in both the peripheral direction and the lengthwise direction. The scattering in the measurement of wall thickness at the like positions was within 126 μm±11 μm. Upon visual observation of the intermediate transfer member (3), none of foreign matter or faulty extrusion such as granular structure and fish eyes was seen on its surface. Also, the primary transfer efficiency and secondary transfer efficiency of this intermediate transfer member (3) were as good as 98% and 96%, respectively.

Next, full-color images were continuously printed on 5,000 sheets in the same manner as in Example 1. Good images were obtainable from the beginning without causing any uneven image density and image blank areas caused by poor transfer, and without causing any color aberration or faulty cleaning ascribable to elongation set of the belt even after running on 5,000 sheets.

After full-color image 5,000-sheet continuous printing in a high temperature/high humidity environment (30° C./80% RH), too, good images not different from those of the initial stage were obtainable without causing any faulty images presumed to be due to variations of electrical resistance of the intermediate transfer member. Moreover, the same surface properties as the initial ones remained unchanged without causing any crazing, abrasion and wear of the surface.

### EXAMPLE 4

To the extruder 100 shown in FIG. 6, having an extrusion die 141 constituted of a spiral die of 180 mm in diameter and 210 μm in die gap width, the extrusion material (1) of Example 1 was fed from a hopper 120, and was extruded in a cylindrical form (a belt). The belt thus extruded was stretched while its inner surface came into contact with a cooling mandrel to become cooled, and was regulated to have the desired size and thickness to obtain an intermediate transfer member (4) of 138 mm in diameter, 130 μm in wall thickness and 250 mm in belt width.

The electrical resistance of this intermediate transfer belt (4) was 6.8×10⁹ Ω. Also, the uniformity of volume resistivity and surface resistivity at the eight spots in the intermediate transfer member as shown in FIG. 8 was within two figures in both the peripheral direction and the lengthwise direction. The scattering in the measurement of wall thickness at the like positions was within 130 μm±10 μm. Upon visual observation of the intermediate transfer member (4), none of foreign matter or faulty extrusion such as granular structure and fish eyes was seen on its surface. Also, the primary transfer efficiency and secondary transfer efficiency of this intermediate transfer member (4) were as good as 94% and 90%, respectively.

Next, full-color images were continuously printed on 5,000 sheets in the same manner as in Example 1. Good images were obtainable from the beginning without causing any uneven image density and image blank areas caused by poor transfer, and without causing any color aberration or faulty cleaning ascribable to elongation set of the belt even after running on 5,000 sheets. Moreover, the same surface properties as the initial ones remained unchanged without causing any crazing, abrasion and wear of the surface.

### COMPARATIVE EXAMPLE 1

An extrusion material (5) was obtained in the same manner as in Example 1 except that 30 parts of conductive carbon was added in place of the lithium perchlorate. Also, the subsequent procedure in Example 1 for producing the intermediate transfer member was repeated to obtain an intermediate transfer member (5) of 142 mm in diameter, 140 μm in wall thickness and 250 mm in belt width.

The electrical resistance of this intermediate transfer member (5) was 1.5×10⁶ Ω, but the values of electrical resistance did not converge during the measurement of electrical resistance, showing unstable measurement. Also, the uniformity of volume resistivity and surface resistivity at the eight spots in the intermediate transfer member as shown in FIG. 8 was beyond three figures in both the peripheral direction and the lengthwise direction, and low-resistance areas and high-resistance areas were locally present. Wall thickness unevenness was 140 μm±20 μm. The primary transfer efficiency and secondary transfer efficiency of this intermediate transfer member (5) were 83% and 80%, respectively.

Full-color images were continuously printed on 5,000 sheets in the same manner as in Example 1, but uneven image density (greatly occurred especially when two colors were superimposed) and image blank areas caused by poor transfer occurred from the beginning.

### COMPARATIVE EXAMPLE 2

An intermediate transfer member (6) of 180 mm in diameter, 130 μm in wall thickness and 250 mm in belt width was obtained in the same manner as in Example 1 except that an extrusion die 140 of 40 mm in diameter was used.

The electrical resistance of this intermediate transfer member (6) was 4.2×10¹⁰ Ω, but the values of electrical resistance did not converge during the measurement of electrical resistance, showing unstable measurement. Also, the uniformity of volume resistivity and surface resistivity at the eight spots in the intermediate transfer member as shown in FIG. 8 was beyond three figures in both the peripheral direction and the lengthwise direction, and low-resistance areas and high-resistance areas were locally present. Wall thickness unevenness was in scattering of as great as 180 μm±30 μm.

The primary transfer efficiency and secondary transfer efficiency of this intermediate transfer member (6) were 84% and 84%, respectively. Full-color images were continuously printed on 5,000 sheets in the same manner as in Example 1, but uneven image density (greatly occurred especially when two colors were superimposed) and image blank areas caused by poor transfer occurred from the beginning, and crazing, scratching and so forth occurred as a result of running.

As described above, the present invention can provide an intermediate transfer member which ensures a very high transfer efficiency from the first image-bearing member to the intermediate transfer member and a very high transfer efficiency from the intermediate transfer member to the second image-bearing member, is superior in applicability, causes neither image blank areas caused by poor transfer nor image density unevenness, and has excellent durability; a process for producing such an intermediate transfer member at a low cost and in a small number of steps; and an image-forming apparatus having the intermediate transfer member.

1. A process for producing an intermediate transfer member having a single-layer structure, usable in an image-forming apparatus in which an image formed on a first image-bearing member is subsequently transferred to a second image-bearing member, the process comprising the steps of:
melt-extruding thermoplastic resin from a circular die by means of an extruder to obtain a cylindrical, extended product; and
forming the resultant cylindrical, extruded product into the intermediate transfer member;
wherein a ratio of a diameter of the intermediate transfer member obtained to a die diameter of the circular die is in the range of 0.5 to 4.0, and
wherein the thermoplastic resin comprises an ion-conductive resistance control agent selected from the group consisting of quaternary ammonium salts containing an anion selected from the group consisting of perchlorate, chlorate, hydroborofluoride, sulfate, ethosulfate, and benzyl halide, in combination with a cation selected from the group consisting of lauryl trimethylammonium, dodecyl trimethylammonium, and hexadecyl trimethylammonium.

2. A process according to claim 1, wherein the ion-conductive resistance control agent is a cationic or anionic surface-active agent.

3. A process according to claim 1, wherein the ion-conductive resistance control agent is a quaternary ammonium salt.

4. A process according to claim 1, wherein the ion-conductive resistance control agent contained in the intermediate transfer member is in an amount of 20% by weight or less.

5. A process according to claim 1, wherein the intermediate transfer member is a semiconductive seamless belt.

6. A process according to claim 1, wherein the intermediate transfer member has an electrical resistance of from 1×10⁰ Ω to 1×10¹⁴ Ω.

7. A process according to claim 1, wherein a maximum value of volume resistivity in the peripheral direction of the intermediate transfer member is within 100 times the minimum value thereof.

8. A process according to claim 1, wherein a maximum value of surface resistivity in the peripheral direction of the intermediate transfer member is within 100 times the minimum value thereof.

9. A process according to claim 1, wherein a maximum value of volume resistivity in the lengthwise direction of the intermediate transfer member is within 100 times the minimum value thereof.

10. A process according to claim 1, wherein a maximum value of surface resistivity in the lengthwise direction of the intermediate transfer member is within 100 times the minimum value thereof.

11. A process according to claim 1, wherein the intermediate transfer member has a wall thickness which is smaller than a die gap of the circular die.

12. A process according to claim 1, wherein the cylindrical, extruded product is taken off at a speed higher than a speed at which the same is extruded from the circular die.

13. A process according to claim 1, wherein the cylindrical, extruded product is inflated by blowing a gas thereinto while being extruded from the circular die.

14. A process according to claim 1, wherein the cylindrical, extruded product obtained is cut at right angles to its lengthwise direction.

15-25. (canceled)
